(19) United States
(12) Patent Application Publication
(10) Pub. No.: US 2020/0307558 A1
(43) Pub. Date: Oct. 1, 2020

(54) VEHICLE CONTROL DEVICE, VEHICLE MANAGEMENT DEVICE, VEHICLE CONTROL METHOD, VEHICLE MANAGEMENT METHOD, AND STORAGE MEDIUM

(71) Applicant: HONDA MOTOR CO., LTD., Tokyo (JP)

(72) Inventors: Junpei Noguchi, Wako-shi (JP); Chie Sugihara, Tokyo (JP); Yuta Takada, Tokyo (JP); Ryoma Taguchi, Tokyo (JP)

(21) Appl. No.: 16/826,480

(22) Filed: Mar. 23, 2020

(30) Foreign Application Priority Data
Mar. 29, 2019 (JP) 2019-065223

(51) Int. Cl. B60W 30/06; G05D 1/02

(52) U.S. Cl. CPC B60W 30/06; B60W 2555/20; G05D 1/0212

(57) ABSTRACT

A vehicle control device mountable in a vehicle includes a predicted time calculator configured to calculate a predicted time required for automated parking of the vehicle at a parking position and a transmitter configured to transmit information regarding the predicted time calculated by the predicted time calculator to a vehicle management device for managing parking of the vehicle.

### CROSS-REFERENCE TO RELATED APPLICATION

This application claims priority to and the benefit from Japanese Patent Application No. 2019-065223, filed on Mar. 29, 2019, the contents of which are hereby incorporated by reference into the present application.

### BACKGROUND

### Field of the Invention

The present invention relates to a vehicle control device, a vehicle management device, a vehicle control method, a vehicle management method, and a storage medium.

### Description of Related Art

In recent years, studies of automated vehicle control have been conducted. An automated parking system in which, in automated valet parking in which this technology is used, a vehicle performs autonomous traveling while searching for an empty parking frame, and a terminal of a user is notified when a parking waiting time is greater than a predetermined time during the searching or a travel distance is equal to or greater than a predetermined distance during waiting for the parking is disclosed (for example, PCT International Publication No. WO 2018/207778).

### SUMMARY

A parking lot management device that manages vehicles in automated valet parking retains information regarding vacancy situations of parking frames, and thus guides vehicles to parking frames based on the information. In the parking management device performing such centralized management, however, vacancy situations of parking frames are ascertained, but site situations of actual parking frames such as congestion situations of vehicles near the parking frames are not ascertained. Therefore, vehicles may be guided to parking frames for which it takes time for parking in some cases.

The present invention is devised in view of such circumstances and an objective of the present invention is to provide a vehicle control device, a vehicle management device, a vehicle control method, a vehicle management method, and a storage medium capable of performing optimum parking control in consideration of a situation of an actual parking position in an automated parking process for automated valet parking.

A vehicle control device, a vehicle management device, a vehicle control method, a vehicle management method, and a storage medium according to the present invention adopt the following configurations.

(1) According to an aspect of the present invention, a vehicle control device mountable in a vehicle includes: a predicted time calculator configured to calculate a predicted time required for automated parking of the vehicle at a parking position; and a transmitter configured to transmit information regarding the predicted time calculated by the predicted time calculator to a vehicle management device for managing parking of the vehicle.

(2) In the vehicle control device according to the aspect (1), the predicted time calculator may calculate the predicted time which is a predicted value of a time necessary to stop at a parking position after the vehicle reaches the parking position and starts a parking operation.

(3) The vehicle control device according to the aspect (1) or (2) may further include a recognizer configured to recognize surrounding information of the vehicle. The predicted time calculator may calculate the predicted time according to the surrounding information recognized by the recognizer.

(4) In the vehicle control device according to the aspect (3), the predicted time calculator may calculate the predicted time, the predicted time in a case in which the surrounding information indicates presence of a factor that has an influence on the automated parking being longer than the predicted time in a case in which the surrounding information does not indicate presence of the factor.

(5) In the vehicle control device according to the aspect (3) or (4), the predicted time calculator may calculate the predicted time, the predicted time in a case in which there is another vehicle near the parking position of the vehicle being longer than the predicted time in a case in which there is no another vehicle near the parking position.

(6) In the vehicle control device according to the aspect (1) or (2), the predicted time calculator may calculate the predicted time according to a period of time in which the vehicle is configured to perform the automated parking.

(7) In the vehicle control device according to any one of the aspects (3) to (6), the predicted time calculator may calculate the predicted time according to brightness or weather of the parking position of the vehicle.

(8) According to another aspect of the present invention, a vehicle management device for managing parking of a vehicle includes: a communicator configured to transmit information regarding a parking position to the vehicle and to receive information regarding a predicted time required for automated parking of the vehicle at the parking position from the vehicle; a determiner configured to determine whether it is necessary to change the parking position according to the predicted time received by the communicator and a target time required for the automated parking; and a parking controller configured to change the parking position and to cause the communicator to transmit information regarding the changed parking position in a case in which the determiner determines that it is necessary to change the parking position.

(9) In the vehicle management device according to the aspect (8), the determiner may determine that it is necessary to change the parking position in a case in which a separation between the predicted time and the target time is equal to or greater than a predetermined time.

(10) In the vehicle management device according to the aspect (8) or (9), the communicator may transmit the target time to the vehicle.

(11) The vehicle management device according to any one of the aspects (8) to (10) may further include a target time calculator configured to calculate the target time according to a past parking result of the vehicle.

(12) In the vehicle management device according to the aspect (11), the target time calculator may calculate an average value of past times required for parking of the vehicle as the target time.

(13) In the vehicle management device according to the aspect (11) or (12), the target time calculator may calculate the target time according to a type of another vehicle stopping at another parking position adjacent to the parking position.

(14) In the vehicle management device according to any one of the aspects (8) to (13), the communicator may receive surrounding information of the vehicle from the vehicle. The determiner may determine that it is necessary to change the parking position in a case in which the surrounding information indicates that there is another vehicle behind the vehicle.

(15) In the vehicle management device according to the aspect (14), the parking controller may change the parking position to another parking position located in a travel direction of the vehicle.

(16) In the vehicle management device according to any one of the aspects (8) to (15), the parking controller may perform control no to set the parking position associated with the predicted time as a parking position of another subsequent vehicle in a case in which the predicted time received by the communicator is greater than a predetermined threshold.

(17) According to still another aspect of the present invention, a vehicle control method using a computer of a vehicle control device mountable in a vehicle includes calculating a predicted time required for automated parking of the vehicle at a parking position; and transmitting information regarding the calculated predicted time to a vehicle management device for managing parking of the vehicle.

(18) According to still another aspect of the present invention, a vehicle management method using a computer of a vehicle management device for managing parking of a vehicle includes transmitting information regarding a parking position to the vehicle and receiving information regarding a predicted time required for automated parking of the vehicle at the parking position from the vehicle; determining whether it is necessary to change the parking position according to the received predicted time and a target time required for the automated parking; and changing the parking position and transmitting information regarding the changed parking position in a case in which it is determined that it is necessary to change the parking position.

(19) According to still another aspect of the present invention, a computer-readable non-transitory storage medium that stores a program causing a computer of a vehicle control device mountable in a vehicle: to calculate a predicted time required for automated parking of the vehicle at a parking position; and to transmit information regarding the calculated predicted time to a vehicle management device for managing parking of the vehicle.

(20) According to still another aspect of the present invention, a computer-readable non-transitory storage medium that stores a program causing a computer of a vehicle management device for managing parking of a vehicle: to transmit information regarding a parking position to the vehicle and to receive information regarding a predicted time required for automated parking of the vehicle at the parking position from the vehicle; to determine whether it is necessary to change the parking position according to the received predicted time and a target time required for the automated parking; and to change the parking position and to transmit information regarding the changed parking position in a case in which it is determined that it is necessary to change the parking position.

According to the aspects (1) to (3) and (8) to (20), optimum parking control in consideration of a situation of an actual parking position can be performed in the automated parking process of automated valet parking. By changing the parking position of the vehicle according to the predicted time calculated in consideration of the situation of the actual parking position, it is possible to shorten a time required for parking in the vehicle and optimize the parking control for another subsequent vehicle.

According to the aspects (4) to (8), by calculating the accurate predicted time according to content of information included in a surrounding situation of a parking position, it is possible to perform more optimum parking control.

### BRIEF DESCRIPTION OF THE DRAWINGS

FIG. 1 is a diagram showing a configuration of a vehicle system in which a vehicle control device according to an embodiment is used.

FIG. 2 is a diagram showing a functional configuration of a first controller and a second controller according to the embodiment.

FIG. 3 is a diagram schematically showing a scenario in which an autonomous parking event according to the embodiment is performed.

FIG. 4 is a diagram showing an example of a configuration of a parking lot management device according to the embodiment.

FIG. 5 is a diagram showing an example of an operation flow at the time of entrance of an autonomous parking event of an automated driving control device and a parking lot management device according to the embodiment.

FIG. 6 is a diagram showing an example of information registered in parking history information according to the embodiment.

FIG. 7 is a diagram showing an aspect in which movement of an own vehicle to a parking space is completed according to the embodiment.

FIG. 8 is a diagram schematically showing a scenario in which there is no factor that has an influence on automated parking according to the embodiment.

FIG. 9 is a diagram schematically showing an example of a scenario in which there is a factor that has an influence on automated parking according to the embodiment.

FIG. 10 is a diagram schematically showing another example of a scenario in which there is a factor that has an influence on the automated parking according to the embodiment.

FIG. 11 is a diagram schematically showing still another example of a scenario in which there is a factor that has an influence on the automated parking according to the embodiment.

FIG. 12 is a diagram schematically showing still another example of a scenario in which there is a factor that has an influence on the automated parking according to the embodiment.

FIG. 13 is a diagram schematically showing still another example of a scenario in which there is a factor that has an influence on the automated parking according to the embodiment.

FIG. 14 is a diagram schematically showing a scenario in which there is a factor disturbing automated parking according to the embodiment.

FIG. 15 is a diagram showing an example of a parking operation for the own vehicle when there is a following vehicle according to the embodiment.

FIG. 16 is a diagram showing an example of a hardware configuration of an automated driving control device according to an embodiment.

### DESCRIPTION OF EMBODIMENTS

Hereinafter, embodiments of a vehicle control device, a vehicle management device, a vehicle control method, a vehicle management method, and a storage medium according to the present invention will be described with reference to the drawings.

### EMBODIMENT

### [Overall Configuration]

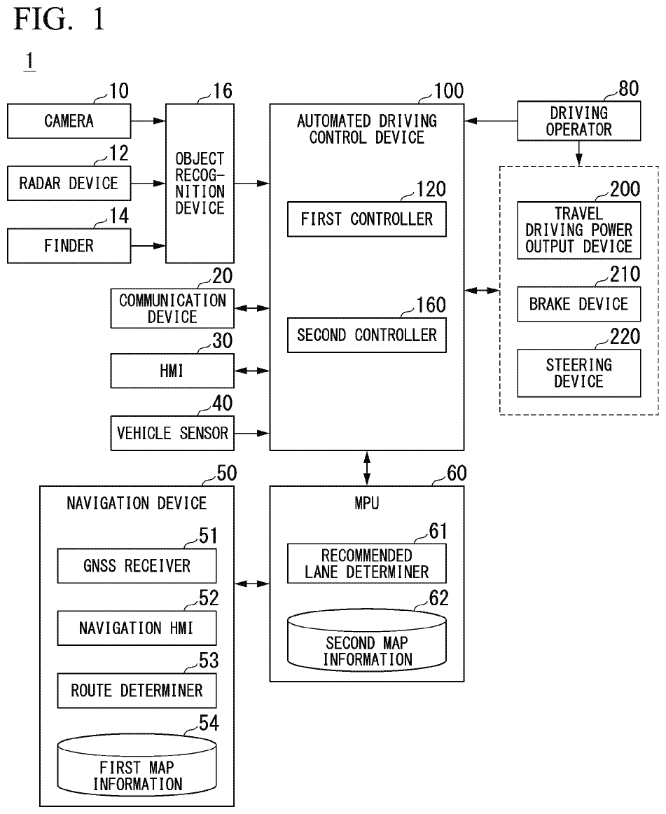

FIG. 1 is a diagram showing a configuration of a vehicle system 1 in which a vehicle control device according to an embodiment is used. A vehicle in which the vehicle system 1 is mounted is, for example, a vehicle such as a two-wheeled vehicle, a three-wheeled vehicle, or a four-wheeled vehicle. A driving source of the vehicle includes an internal combustion engine such as a diesel engine or a gasoline engine, an electric motor, and a combination thereof. The electric motor operates using power generated by a power generator connected to the internal combustion engine or power discharged from a secondary cell or a fuel cell.

The vehicle system 1 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, a driving operator 80, an automated driving control device 100 (an example of a “vehicle control device”), a travel driving power output device 200, a brake device 210, and a steering device 220. The devices and units are connected to one another via a multiplex communication line such as a controller area network (CAN) communication line, a serial communication line, or a wireless communication network. The configuration shown in FIG. 1 is merely exemplary, a part of the configuration may be omitted, and another configuration may be further added.

The camera 10 is, for example, a digital camera that uses a solid-state image sensor such as a charged coupled device (CCD) or a complementary metal oxide semiconductor (CMOS). The camera 10 is mounted on any portion of a vehicle in which the vehicle control system 1 is mounted. When the camera 10 images a front side, the camera 10 is mounted on an upper portion of a front windshield, a rear surface of a rearview mirror, and the like. For example, the camera 10 repeatedly images the surroundings of an own vehicle M periodically. The camera 10 may be a stereo camera.

The radar device 12 radiates radio waves such as millimeter waves to the surroundings of the own vehicle M and detects radio waves (reflected waves) reflected from an object to detect at least a position (a distance and an azimuth) of the object. The radar device 12 is mounted on any portion of the own vehicle M. The radar device 12 may detect a position and a speed of an object in conformity with a frequency modulated continuous wave (FM-CW) scheme.

The finder 14 is a light detection and ranging (LIDAR) finder. The finder 14 radiates light to the surroundings of the own vehicle M and measures scattered light. The finder 14 detects a distance to a target based on a time from light emission to light reception. The radiated light is, for example, pulsed laser light. The finder 14 is mounted on any portions of the own vehicle M.

The object recognition device 16 performs a sensor fusion process on detection results from some or all of the camera 10, the radar device 12, and the finder 14 and recognizes a position, a type, a speed, and the like of an object. The object recognition device 16 outputs a recognition result to the automated driving control device 100. The object recognition device 16 may output detection results of the camera 10, the radar device 12, and the finder 14 to the automated driving control device 100 without any change. The object recognition device 16 may be excluded from the vehicle system 1.

The communication device 20 communicates with other vehicles around the own vehicle M using, for example, a cellular network, a Wi-Fi network, Bluetooth (registered trademark), dedicated short range communication (DSRC) or the like or communicates with a parking lot management device or various server devices. The details of a function of the parking lot management device will be described later.

The HMI 30 presents various types of information to occupants of the own vehicle M and receives input operations by the occupants. For example, the HMI 30 includes various display devices, speakers, buzzers, touch panels, switches, and keys.

The vehicle sensor 40 includes a vehicle speed sensor that detects a speed of the own vehicle M, an acceleration sensor that detects acceleration, a yaw rate sensor that detects angular velocity around a vertical axis, and an azimuth sensor that detects a direction of the own vehicle M.

The navigation device 50 includes, for example, a global navigation satellite system (GNSS) receiver 51, a navigation HMI 52, and a route determiner 53. The navigation device 50 retains first map information 54 in a storage device such as a hard disk drive (HDD) or a flash memory. The GNSS receiver 51 specifies a position of the own vehicle M based on signals received from GNSS satellites. The position of the own vehicle M may be specified or complemented by an inertial navigation system (INS) using an output of the vehicle sensor 40. The navigation HMI 52 includes a display device, a speaker, a touch panel, and a key. The navigation HMI 52 may be partially or entirely common to the above-described HMI 30. The route determiner 53 determines, for example, a route from a position of the own vehicle M specified by the GNSS receiver 51 (or any input position) to a destination input by an occupant using the navigation HMI 52 (hereinafter referred to as a route on a map) with reference to the first map information 54. The first map information 54 is, for example, information in which a road shape is expressed by links indicating roads and nodes connected by the links. The first map information 54 may include curvatures of roads and point of interest (POI) information. The route on the map is output to the MPU 60. The navigation device 50 may perform route guidance using the navigation HMI 52 based on the route on the map. The navigation device 50 may be realized by, for example, a function of a terminal device such as a smartphone or a tablet terminal possessed by an occupant. The navigation device 50 may transmit a present position and a destination to a navigation server via the communication device 20 to acquire the same route as the route on the map from the navigation server.

The MPU 60 includes, for example, a recommended lane determiner 61 and retains second map information 62 in a storage device such as an HDD or a flash memory. The recommended lane determiner 61 divides the route on the map provided from the navigation device 50 into a plurality of blocks (for example, divides the route in a vehicle movement direction for each 100 [m]) and determines a recommended lane for each block with reference to the second map information 62. The recommended lane determiner 61 determines in which lane the vehicle travels from the left. When there is a branching location in the route on the map, the recommended lane determiner 61 determines a recommended lane so that the own vehicle M can travel in a reasonable route to move to a branching destination.

The second map information 62 is map information that has higher precision than the first map information 54. The second map information 62 includes, for example, information regarding the middles of lanes or information regarding boundaries of lanes. The second map information 62 may include road information, traffic regulation information, address information (address and postal number), facility information, and telephone number information. The second map information 62 may be updated frequently by communicating with another device using the communication device 20.

The driving operator 80 includes, for example, an accelerator pedal, a brake pedal, a shift lever, a steering wheel with a different shape, a joystick, and other operators. A sensor that detects whether there is an operation or an operation amount is mounted in the driving operator 80 and a detection result is output to the automated driving control device 100 or some or all of the travel driving power output device 200, the brake device 210, and the steering device 220.

The automated driving control device 100 includes, for example, a first controller 120 and a second controller 160. Each of the first controller 120 and the second controller 160 is realized, for example, by causing a hardware processor such as a central processing unit (CPU) to execute a program (software). Some or all of the constituent elements may be realized by hardware (a circuit unit including circuitry) such as a large scale integration (LSI), an application specific integrated circuit (ASIC), a field-programmable gate array (FPGA), or a graphics processing unit (GPU) or may be realized by software and hardware in cooperation. The program may be stored in advance in a storage device (a storage device including a non-transitory storage medium) such as an HDD or a flash memory of the automated driving control device 100 or may be stored in a storage medium (a non-transitory storage medium) detachably mounted on a DVD, a CD-ROM, or the like so that the storage medium is mounted on a drive device to be installed on the HDD or the flash memory of the automated driving control device 100.

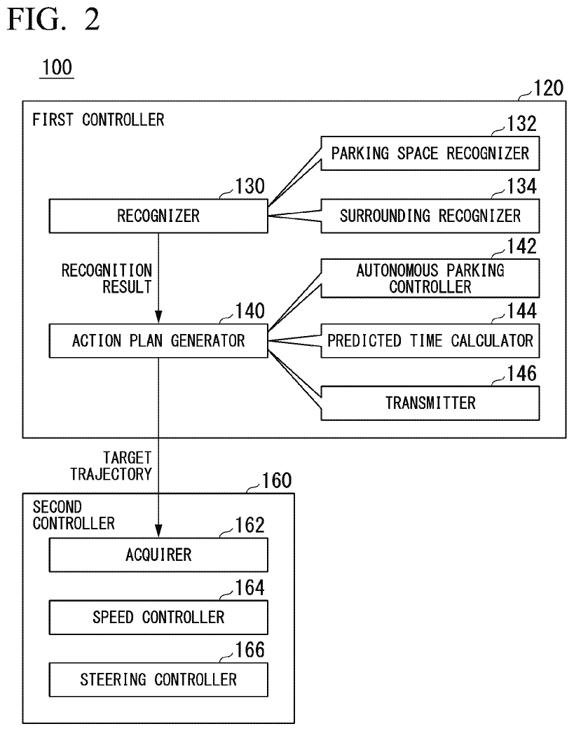

FIG. 2 is a diagram showing a functional configuration of the first controller 120 and the second controller 160 according to the embodiment. The first controller 120 includes, for example, a recognizer 130 and an action plan generator 140. The first controller 120 realizes, for example, a function by artificial intelligence (AI) and a function by a model given in advance in parallel. For example, a function of “recognizing an intersection” may be realized by performing recognition of an intersection by deep learning or the like and recognition based on a condition given in advance (a signal, a road sign, or the like which can be subjected to pattern matching) in parallel, scoring both the recognitions, and performing evaluation comprehensively. Thus, reliability of automated driving is guaranteed.

The recognizer 130 recognizes states such as positions, speeds, or acceleration of objects around the own vehicle M based on information input from the camera 10, the radar device 12, and the finder 14 via the object recognition device 16. For example, the positions of the objects are recognized as positions on the absolute coordinates in which a representative point (a center of gravity, a center of a driving shaft, or the like) of the own vehicle M is the origin and are used for control. The positions of the objects may be represented as representative points such as centers of gravity, corners, or the like of the objects or may be represented as expressed regions. A “state” of an object may include acceleration or jerk of the object or an “action state” (for example, whether a vehicle is changing a lane or is attempting to change the lane).

The recognizer 130 recognizes, for example, a lane in which the own vehicle M is traveling (a travel lane). For example, the recognizer 130 recognizes the travel lane by comparing patterns of road mark lines (for example, arrangement of continuous lines and broken lines) obtained from the second map information 62 with patterns of road mark lines around the own vehicle M recognized from images captured by the camera 10. The recognizer 130 may recognize a travel lane by mainly recognizing runway boundaries (road boundaries) including road mark lines or shoulders, curbstones, median strips, and guardrails without being limited to road mark lines. In this recognition, the position of the own vehicle M acquired from the navigation device 50 or a process result by INS may be added. The recognizer 130 recognizes temporary stop lines, obstacles, red signals, toll gates, and other road events.

The recognizer 130 recognizes a position or a posture of the own vehicle M with respect to the travel lane when the recognizer 130 recognizes the travel lane. For example, the recognizer 130 may recognize a deviation from the middle of a lane of a standard point of the own vehicle M and an angle formed with a line extending along the middle of a lane in the travel direction of the own vehicle M as a relative position and posture of the own vehicle M to the travel lane. Instead of this, the recognizer 130 may recognize a position or the like of the standard point of the own vehicle M with respect to a side end portion (a road mark line or a road boundary) of any travel lane as the relative position of the own vehicle M to the travel lane.

The recognizer 130 includes a parking space recognizer 132 and a surrounding recognizer 134 that are activated in an autonomous parking event to be described below. The details of functions of the parking space recognizer 132 and the surrounding recognizer 134 will be described later.

The action plan generator 140 generates a target trajectory along which the own vehicle M travels in future automatically (irrespective of an operation of a driver or the like) so that the own vehicle M is traveling along a recommended lane determined by the recommended lane determiner 61 and handles a surrounding situation of the own vehicle M in principle. The target trajectory includes, for example, a speed component. For example, the target trajectory is expressed by arranging spots (trajectory points) at which the own vehicle M will arrive in sequence. The trajectory point is a spot at which the own vehicle M will arrive for each predetermined travel distance (for example, about several [m]) in a distance along a road. Apart from the trajectory points, target acceleration and a target speed are generated as parts of the target trajectory for each of predetermined sampling times (for example, about a decimal point of a second). The trajectory point may be a position at which the own vehicle M will arrive at the sampling time for each predetermined sampling time. In this case, information regarding the target acceleration or the target speed is expressed according to an interval between the trajectory points.

The action plan generator 140 may set an automated driving event when the target trajectory is generated. As the automated driving event, there are a constant speed traveling event, a low speed track traveling event, a lane changing event, a branching event, a joining event, a takeover event, an autonomous parking event in which autonomous parking are performed in valet parking or the like, and an autonomous pickup event in which an autonomous exit is performed from a parking lot and autonomous travel is performed to a predetermined boarding position in valet parking or the like, and the like. The action plan generator 140 generates the target trajectory in accordance with an activated event. The action plan generator 140 includes an autonomous parking controller 142, a predicted time calculator 144 (an example of a “predicted time calculator”), and a transmitter 146 (an example of a “transmitter”) that are activated when an autonomous parking event is performed. The details of functions of the autonomous parking controller 142, the predicted time calculator 144, and the transmitter 146 will be described later.

The second controller 160 controls the travel driving power output device 200, the brake device 210, and the steering device 220 so that the own vehicle M passes along the target trajectory generated by the action plan generator 140 at a scheduled time.

Referring back to FIG. 2, the second controller 160 includes, for example, an acquirer 162, a speed controller 164, and a steering controller 166. The acquirer 162 acquires information regarding the target trajectory (trajectory points) generated by the action plan generator 140 and stores the information in a memory (not shown). The speed controller 164 controls the travel driving power output device 200 or the brake device 210 based on a speed element incidental to the target trajectory stored in the memory. The steering controller 166 controls the steering device 220 in accordance with a curve state of the target trajectory stored in the memory. Processes of the speed controller 164 and the steering controller 166 are realized, for example, by combining feed-forward control and feedback control. For example, the steering controller 166 performs the feed-forward control in accordance with a curvature of a road in front of the own vehicle M and the feedback control based on separation from the target trajectory in combination.

The travel driving power output device 200 outputs a travel driving power (torque) for traveling the vehicle to a driving wheel. The travel driving power output device 200 includes, for example, a combination of an internal combustion engine, an electric motor and a transmission, and an electronic control unit (ECU) controlling these units. The ECU controls the foregoing configuration in accordance with information input from the second controller 160 or information input from the driving operator 80.

The brake device 210 includes, for example, a brake caliper, a cylinder that transmits a hydraulic pressure to the brake caliper, an electronic motor that generates a hydraulic pressure to the cylinder, and a brake ECU. The brake ECU controls the electric motor in accordance with information input from the second controller 160 or information input from the driving operator 80 such that a brake torque in accordance with a brake operation is output to each wheel. The brake device 210 may include a mechanism that transmits a hydraulic pressure generated in response to an operation of the brake pedal included in the driving operator 80 to the cylinder via a master cylinder as a backup. The brake device 210 is not limited to the above-described configuration and may be an electronic control type hydraulic brake device that controls an actuator in accordance with information input from the second controller 160 such that a hydraulic pressure of the master cylinder is transmitted to the cylinder.

The steering device 220 includes, for example, a steering ECU and an electric motor. The electric motor works a force to, for example, a rack and pinion mechanism to change a direction of a steering wheel. The steering ECU drives the electric motor to change the direction of the steering wheel in accordance with information input from the second controller 160 or information input from the driving operator 80.

### [Autonomous Parking Event: At Time of Entrance]

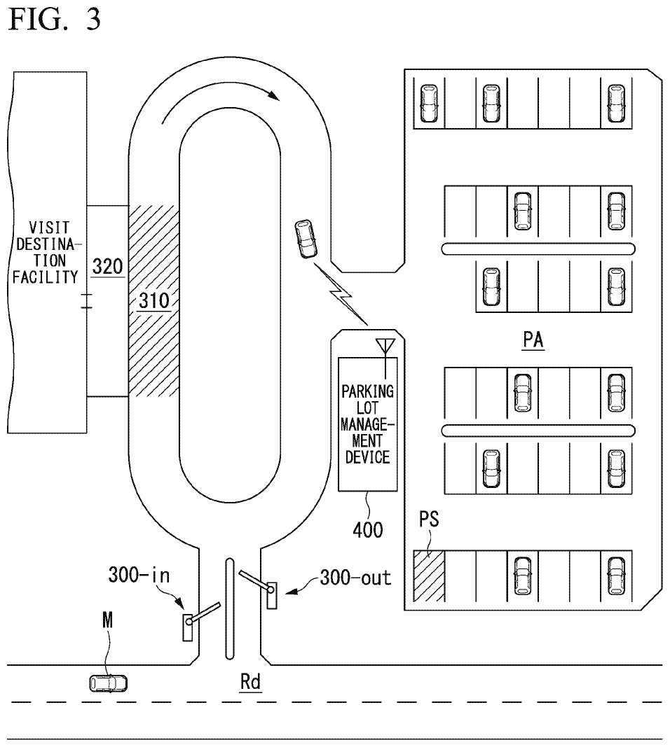

For example, the autonomous parking controller 142 parks the own vehicle M in a parking space based on information acquired from a parking lot management device 400 through the communication device 20. FIG. 3 is a diagram schematically showing a scenario in which an autonomous parking event according to the embodiment is performed. Gates 300-in and 300-out are provided on a route from a road Rd to a visit destination facility. The own vehicle M passes through the gate 300-in through manual driving or automated driving and enters to a stopping area 310. The stopping area 310 faces a boarding area 320 connected to the visit destination facility. In the boarding area 320, an eave is provided to block rain and snow.

After an occupant gets out of a vehicle in the stopping area 310, the own vehicle M performs automated driving and starts an autonomous parking event for moving to a parking space PS in the parking area PA. A trigger to start the autonomous parking event may be, for example, any operation by the occupant or may be wireless reception of a predetermined signal from the parking lot management device 400. When the autonomous parking event starts, the autonomous parking controller 142 controls the communication device 20 such that a parking request is transmitted to the parking lot management device 400. Then, the own vehicle M moves in accordance with guidance of the parking lot management device 400 or moves performing sensing by itself from the stopping area 310 to the parking area PA.

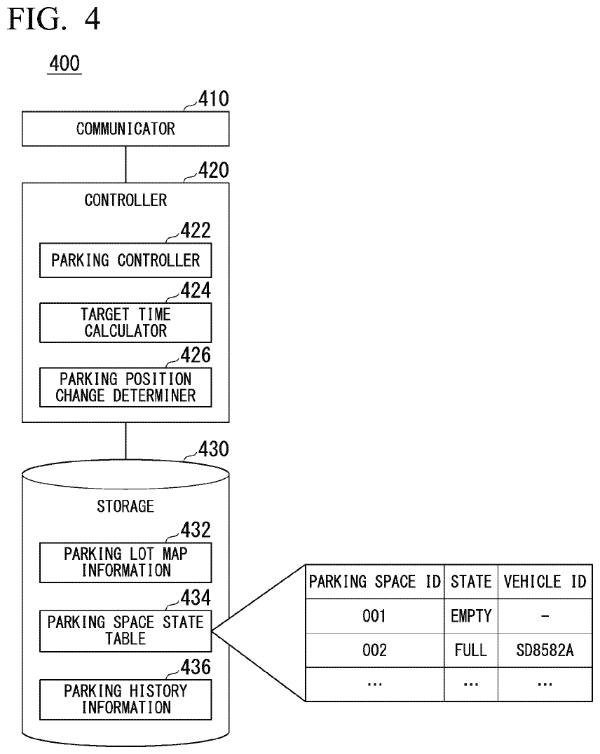

FIG. 4 is a diagram showing an example of a configuration of the parking lot management device 400 according to the embodiment. The parking lot management device 400 includes, for example, a communicator 410, a controller 420, and a storage 430. The storage 430 stores information such as parking lot map information 432, a parking space state table 434, and parking history information 436.

The communicator 410 communicates with the own vehicle M and other vehicles wirelessly. The controller 420 guides a vehicle to the parking space PS based on information acquired by the communicator 410 and information stored in the storage 430. The parking lot map information 432 is information that geometrically represents a structure of the parking area PA. The parking lot map information 432 includes coordinates of each parking space PS. In the parking space state table 434, for example, a state which indicates an empty state and a full (parking) state and a vehicle ID which is identification information of a vehicle parked in the case of the full state are associated with a parking space ID which is identification information of the parking space PS. The details of the parking history information 436 will be described later.

The controller 420 includes, for example, a parking controller 422, a target time calculator 424 (an example of a “target time calculator”), and a parking position change determiner 426 (an example of a “determiner”). When the communicator 410 receives a parking request from a vehicle, the parking controller 422 extracts the parking space PS of which a state is an empty state with reference to the parking space state table 434, acquires a position of the extracted parking space PS from the parking lot map information 432, and transmits a suitable route to the acquired position of the parking space PS to the vehicle through the communicator 410. The parking controller 422 instructs a specific vehicle to stop or move slowly, as necessary, based on a positional relation between a plurality of vehicles so that the vehicles do not simultaneously advance to the same position. The details of functions of the target time calculator 424 and the parking position change determiner 426 will be described later.

In a vehicle receiving the route (hereinafter, assumed to be the own vehicle M), the autonomous parking controller 142 generates a target trajectory based on the route. When the own vehicle M approaches the parking space PS which is a target, the parking space recognizer 132 recognizes parking frame lines or the like marking the parking space PS, recognizes a detailed position of the parking space PS, and supplies the detailed position of the parking space PS to the autonomous parking controller 142. The autonomous parking controller 142 receives the detailed position of the parking space PS, corrects the target trajectory, and parks the own vehicle M in the parking space PS.

### [Autonomous Parking Event: At Time of Exit]

The autonomous parking controller 142 and the communication device 20 are maintained in an operation state even while the own vehicle M is parked. For example, when the communication device 20 receives a pickup request from a terminal device owned by an occupant, the autonomous parking controller 142 activates a system of the own vehicle M and causes the own vehicle M to move to the stopping area 310. At this time, the autonomous parking controller 142 controls the communication device 20 to transmit a launch request to the parking lot management device 400. The controller 420 of the parking lot management device 400 instructs a specific vehicle to stop or move slowly, as necessary, based on a positional relation between a plurality of vehicles so that the vehicles do not simultaneously enter to the same position, as in the time of entrance. When the own vehicle M is caused to move to the stopping area 310 and picks up the occupant, the autonomous parking controller 142 stops the operation. Thereafter, manual driving or automated driving by another functional unit starts.

The present invention is not limited to the above description. The autonomous parking controller 142 may find an empty parking space by itself based on a detection result by the camera 10, the radar device 12, the finder 14, or the object recognition device 16 irrespective of communication and may cause the own vehicle M to park in the found parking space.

### [Autonomous Parking Event: Operation Flow at Time of Entrance]

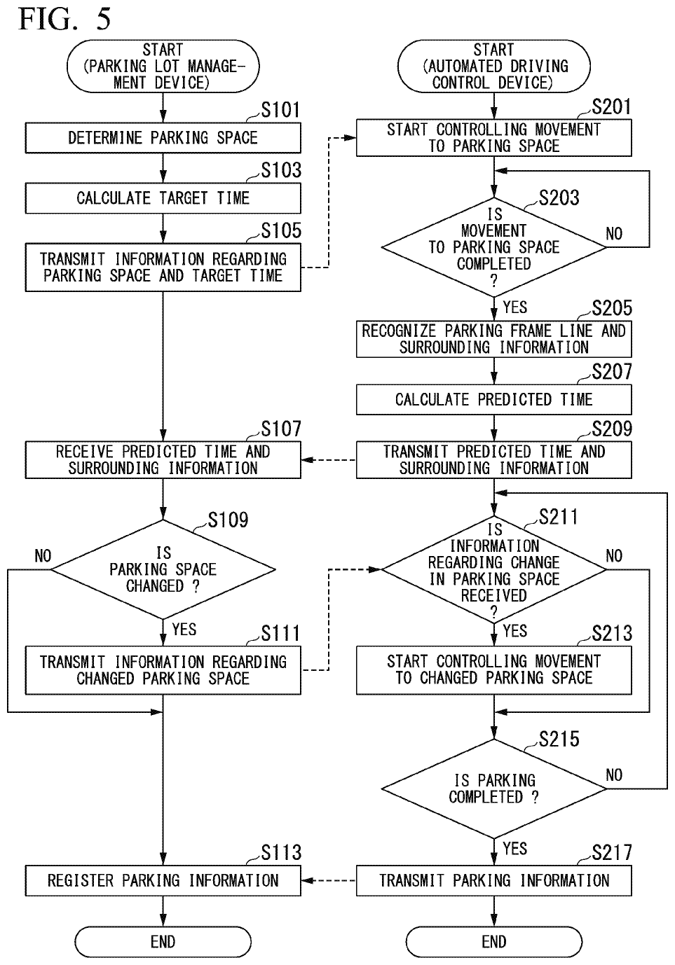

An operation at the time of entrance of the autonomous parking event described above will be described. FIG. 5 is a diagram showing an example of an operation flow at the time of entrance of an autonomous parking event of the automated driving control device 100 and the parking lot management device 400 according to the embodiment.

First, when the communicator 410 of the parking lot management device 400 acquires a parking request transmitted by the own vehicle M, the parking controller 422 of the parking lot management device 400 determines a parking space PS (a parking position) in which the own vehicle M is allowed to park based on information acquired by the communicator 410 and information of the parking space state table 434 stored in the storage 430 (step S101).

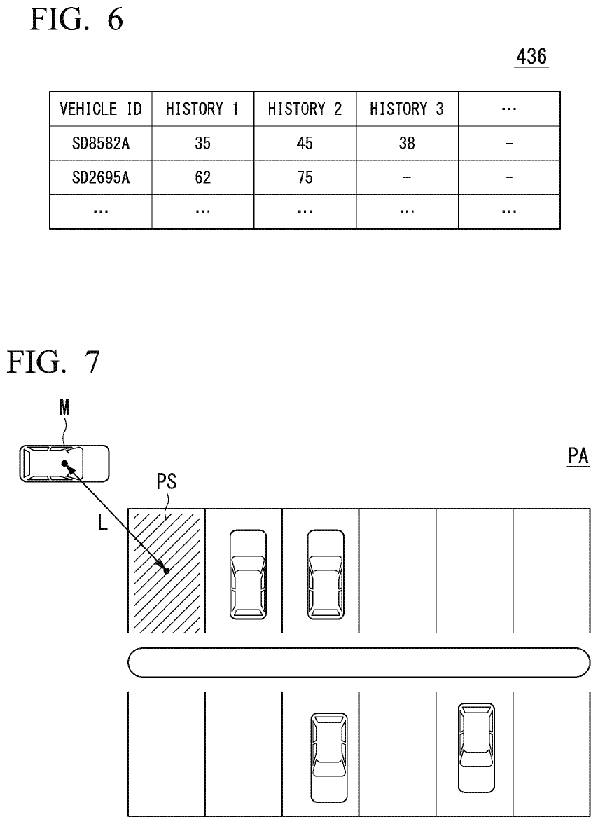

Subsequently, the target time calculator 424 of the parking lot management device 400 calculates a target time based on the information of the parking history information 436 stored in the storage 430 (step S103). The “target time” indicates a target value of a time required to park when the vehicle arrives at the parking space PS in which the vehicle is scheduled to park (completes movement to the parking space), starts a parking operation, stops at the parking space PS, and then completes the parking operation. FIG. 6 is a diagram showing an example of information registered in the parking history information 436 according to the embodiment. In the parking history information 436, a vehicle ID which is identification information of a vehicle and a result value of the time required to park (a past parking result) measured in a past parking operation are associated. The target time calculator 424 calculates a target time based on the result value of the time required to park associated with the vehicle ID specified based on information acquired by the communicator 410. For example, the target time calculator 424 calculates an average value of result values of the time required to park and sets the average value as the target time.

The target time calculator 424 may calculate a longer target time when another vehicle has stopped in a parking space adjacent to the parking space PS in which the own vehicle M is scheduled to park than when another vehicle is not in an adjacent parking space. The target time calculator 424 may calculate the target time based on a kind of another vehicle stopped in another parking space adjacent to the parking space PS.

Subsequently, the parking controller 422 transmits information regarding a suitable route to the position of the determined parking space PS and the calculated target time to the own vehicle M via the communicator 410 (step S105).

Subsequently, the autonomous parking controller 142 of the automated driving control device 100 mounted in the own vehicle M starts controlling movement to the parking space PS of the own vehicle M based on the route received from the parking lot management device 400 (step S201).

Subsequently, the autonomous parking controller 142 of the automated driving control device 100 determines whether the movement of the own vehicle M to the parking space Ps is completed based on route information received from the parking lot management device 400 and positional information of the own vehicle M input from the navigation device 50 (step S203). FIG. 7 is a diagram showing an aspect in which the movement of the own vehicle M to the parking space PS is completed according to the embodiment. As shown in FIG. 7, for example, the autonomous parking controller 142 determines that the movement of the own vehicle M to the parking space PS is completed when a distance between the parking space PS and the position of the own vehicle M is equal to or less than a predetermined threshold L.

When the autonomous parking controller 142 determines that the movement of the own vehicle M to the parking space PS is not completed, the autonomous parking controller 142 continues this determination. Conversely, when the autonomous parking controller 142 determines that the movement of the own vehicle M to the parking space PS is completed, the parking space recognizer 132 recognizes a parking frame line demarcating the parking space PS and the surrounding recognizer 134 recognizes surrounding information on the surroundings of the own vehicle M (surroundings of the parking space PS) (step S205). The surrounding recognizer 134 recognizes the surrounding information based on information input from the camera 10, the radar device 12, and the finder 14 via the object recognition device 16. The surrounding information includes, for example, information regarding an object which is near the own vehicle M, information regarding another vehicle located near the own vehicle M (for example, information regarding another vehicle located in front of or behind the own vehicle M), information regarding a parking space adjacent to the parking space PS (for example, information regarding presence or absence of another vehicle stopping in an adjacent parking space or the position of the other vehicle), information regarding the weather such as solar radiation near the parking space PS (for example, information regarding brightness), and information regarding a parking frame line of the parking space PS (information regarding the ability to discern the parking frame line). When a parking operation by the autonomous parking controller 142 (an invasion operation to a background of the parking space PS) is started, the surrounding recognizer 134 may recognize the surrounding information.

Subsequently, the predicted time calculator 144 of the automated driving control device 100 calculates a predicted time based on the surrounding information of the parking space PS recognized by the surrounding recognizer 134 (step S207). The “predicted time” indicates a predicted value of a time required to park when the vehicle arrives at the parking space PS in which the vehicle is scheduled to park (completes movement to the parking space), starts a parking operation, stops at the parking space PS, and then completes the parking operation. The predicted time is calculated based on the surrounding information of the parking space PS (surrounding information of the parking space PS in real time of a field when parking is performed). Therefore, the predicted time is estimated to have higher precision than a target time calculated based on a result value of a past time required to park. The predicted time calculator 144 calculates the predicted time as follows, for example.

<Case in which there is No Factor that has Influence on Automated Parking>

When the surrounding information of the parking space PS is analyzed and it is determined that there is no factor that has an influence on the automated parking, the predicted time calculator 144 calculates a parking operation time of a standard (hereinafter referred to as a “standard time required for parking”) as a predicted time. The standard time required for parking indicates a time necessary when the vehicle starts the parking operation, stops in the parking space PS, and then completes the parking operation, for example, when the vehicle performs the parking operation along a shortest target trajectory (without considering an influence of the outside) based on control by the autonomous parking controller 142. The standard time required for parking may be based on a result value of a time required for parking at the time of past parking (for example, may be an average value of past times required for parking).

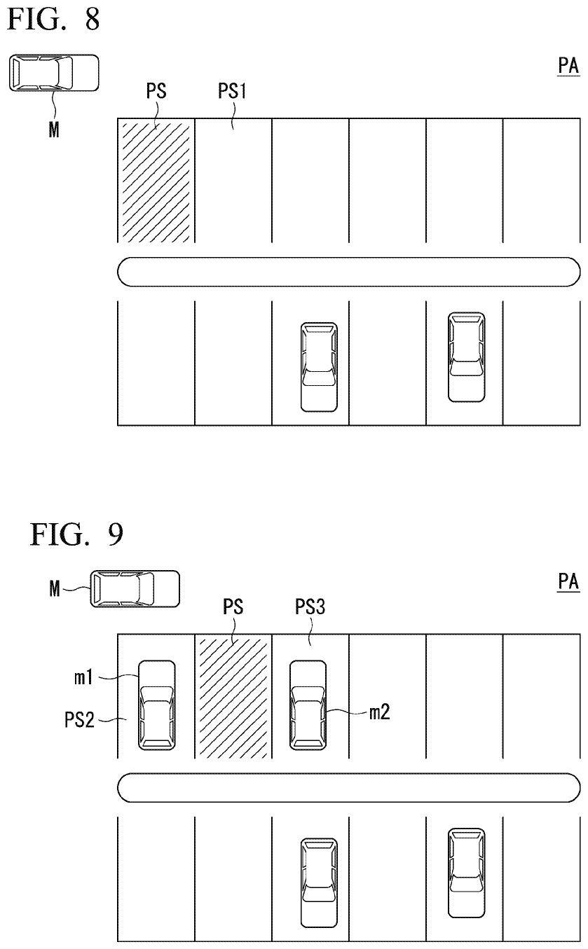

FIG. 8 is a diagram schematically showing a scenario in which there is no factor that has an influence on automated parking according to the embodiment. In the example shown in FIG. 8, another vehicle does not stop in a parking space SP1 adjacent to the parking space PS and still another vehicle is not in a passage near the parking space PS. In this case, the predicted time calculator 144 calculates the standard time required for parking as the predicted time.

<Case in which there is Factor that has Influence on Automated Parking>

When the surrounding information of the parking space PS is analyzed and it is determined that there is a factor that has an influence on the automated parking, the predicted time calculator 144 calculates a time obtained by adding a predetermined additional time to the standard time required for parking as the predicted time.

FIG. 9 is a diagram schematically showing an example of a scenario in which there is a factor that has an influence on automated parking according to the embodiment. In the example shown in FIG. 9, other vehicles m1 and m2 are stopping in parking spaces PS2 and PS3 adjacent to the parking space PS, respectively. In this situation, when the own vehicle M is allowed to park in the parking space PS, a target trajectory is set so that a collision with the other vehicles m1 and m2 is avoided. Therefore, a time required for a parking operation is longer than the standard time required for parking. Therefore, the predicted time calculator 144 calculates a time obtained by adding a predetermined additional time (a first additional time) to the standard time required for parking as a predicted time.

FIG. 10 is a diagram schematically showing another example of a scenario in which there is a factor that has an influence on the automated parking according to the embodiment. In the example shown in FIG. 10, the other vehicles m1 and m2 are stopping at positions close to the parking space PS in the parking spaces PS2 and PS3 adjacent to the parking space PS, respectively. In this situation, when the own vehicle M is allowed to park in the parking space PS, a target trajectory is set so that a collision with the other vehicles m1 and m2 is avoided. Therefore, a time required for a parking operation is longer than the standard time required for parking. A time required for the parking operation in the example shown in FIG. 10 is yet longer than a time required for the parking operation in the example shown in FIG. 9 (an example in which the other vehicles are stopping close to the middles of the parking spaces and there are margins between the other vehicles and the parking spaces PS). Therefore, the predicted time calculator 144 calculates a time obtained by adding a predetermined additional time (a second additional time) to the standard time required for parking as a predicted time. The second additional time may be longer than the first additional time.

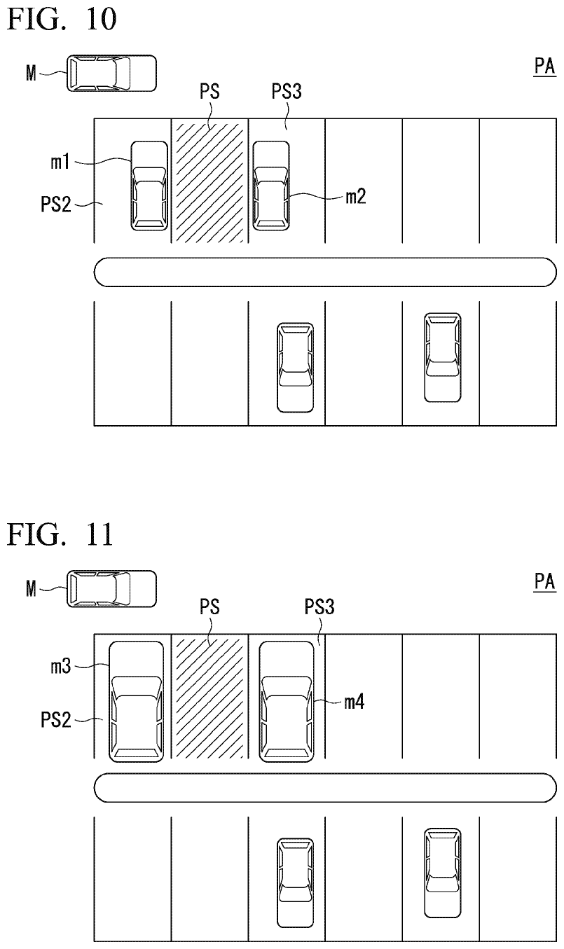

FIG. 11 is a diagram schematically showing still another example of a scenario in which there is a factor that has an influence on the automated parking according to the embodiment. In the example shown in FIG. 11, other large vehicles m3 and m4 are stopping in the parking spaces PS2 and PS3 adjacent to the parking space PS, respectively. In this situation, when the own vehicle M is allowed to park in the parking space PS, a target trajectory is set so that a collision with the other large vehicles m3 and m4 is avoided. Therefore, a time required for a parking operation is longer than the standard time required for parking. Therefore, the predicted time calculator 144 calculates a time obtained by adding a predetermined additional time (a third additional time) to the standard time required for parking as a predicted time. The third additional time may be longer than the first additional time.

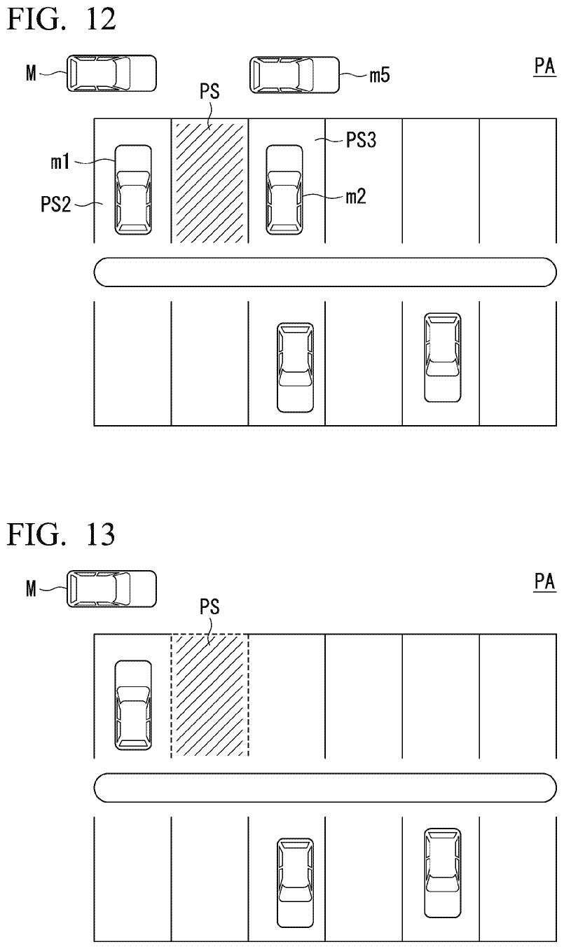

FIG. 12 is a diagram schematically showing still another example of a scenario in which there is a factor that has an influence on the automated parking according to the embodiment. In the example shown in FIG. 12, other vehicles m1 and m2 are stopping in the parking spaces PS2 and PS3 adjacent to the parking space PS, respectively. In addition, still another vehicle m5 is in a passage close to the parking space and is in front of the own vehicle M. In this situation, when the own vehicle M is allowed to park in the parking space PS, a target trajectory is set so that a collision with the other vehicles m1, m2, and m5 is avoided. Therefore, a time required for a parking operation is longer than the standard time required for parking. Therefore, the predicted time calculator 144 calculates a time obtained by adding a predetermined additional time (a fourth additional time) to the standard time required for parking as a predicted time. The fourth additional time may be longer than the first additional time. The fourth additional time may be longer than the second additional time.

FIG. 13 is a diagram schematically showing still another example of a scenario in which there is a factor that has an influence on the automated parking according to the embodiment. In the example shown in FIG. 13, the ability to discern the parking frame line of the parking space PS degrades. Examples of a case in which the ability to discern the parking frame lines (identification is difficult) is reduced include a case in which brightness near the parking space PS is low (a case of unfavorable weather, nighttime, or the like), and a case in which a parking frame line nearly disappears or disappears. In this situation, when the own vehicle M is allowed to park in the parking space PS, a time to identify the parking frame line is necessary. Therefore, the time required for the parking operation is longer than the standard time required for parking. Therefore, the predicted time calculator 144 calculates a time obtained by adding a predetermined additional time (a fifth additional time) to the standard time required for parking as a predicted time. The predicted time calculator 144 calculates the predicted time based on a period of time in which the own vehicle M performs the automated parking. The predicted time calculator 144 calculates a predicted time based on the weather or brightness of the parking space PS.

<Case in which there is Factor that Disturbs Automated Parking>

When the surrounding information of the parking space PS is analyzed and it is determined that there is a factor that disturbs the automated parking (a factor that has an influence thereon), the predicted time calculator 144 calculates a time obtained by adding a predetermined additional time to the standard time required for parking as the predicted time.

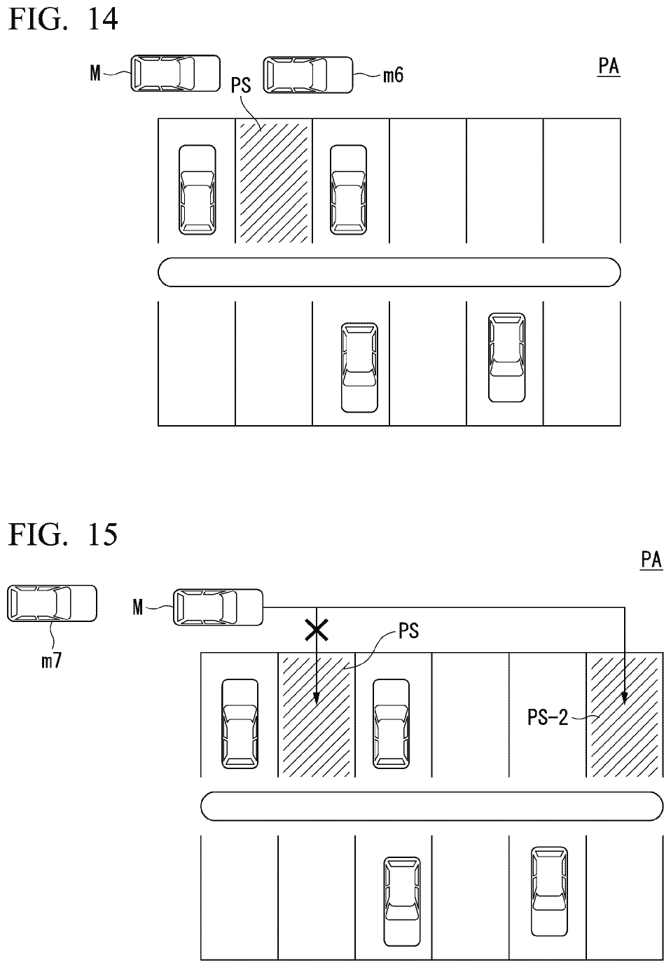

FIG. 14 is a diagram schematically showing a scenario in which there is a factor disturbing automated parking according to the embodiment. In the example shown in FIG. 14, still another vehicle m6 is in front of the own vehicle M in a passage and is at a position at which movement of the own vehicle M to the parking space PS is disturbed. In this situation, when the own vehicle M is allowed to park in the parking space PS, it is necessary to wait for movement of the other vehicle m6. Therefore, a time required for a parking operation is longer than the standard time required for parking. Therefore, the predicted time calculator 144 calculates a time obtained by adding a predetermined additional time (a sixth additional time) to the standard time required for parking as a predicted time. The sixth additional time may be longer than the first to fifth additional times.

In another example shown in FIG. 14, when a certain object disturbing parking is in a passage to the parking space PS or in the parking space PS, when another vehicle stopping in a parking space adjacent to the parking space PS performs an exit operation, or the like, the predicted time calculator 144 determines that there is a factor that disturbs the parking operation and calculates a time obtained by adding a predetermined additional time to the standard time required for parking as a predicted time.

As described above, the predicted time calculator 144 calculates the predicted time so that a predicted time in a case in which the surrounding information indicates that there is a factor that has an influence on the automated parking of the own vehicle M is longer than a predicted time in a case in which there is no factor that has an influence on the automated parking. The predicted time calculator 144 calculates the predicted time so that the predicted time in a case in which another vehicle is near a parking position is longer than a predicted time in a case in which no vehicle is near the parking position.

Referring back to FIG. 5, the transmitter 146 of the automated driving control device 100 transmits the predicted time calculated by the predicted time calculator 144 and the surrounding information recognized by the surrounding recognizer 134 to the parking lot management device 400 (step S209). The automated driving control device 100 receives the predicted time and the surrounding information transmitted in the automated driving control device 100 (step S107).

Subsequently, the parking position change determiner 426 of the automated driving control device 100 determines whether it is necessary to change the parking space based on the predicted time received from the automated driving control device 100, and/or the surrounding information and the target time (step S109). For example, when a value obtained by subtracting the target time from the predicted time is equal to or greater than a predetermined threshold (for example, when the predicted time is considerably greater than the target time or when a separation between the predicted time and the target time is equal to or greater than a predetermined time), the parking position change determiner 426 determines that it is necessary to change the parking space.

The parking position change determiner 426 may change the threshold based on the surrounding information. For example, when the surrounding information indicates that another vehicle (another vehicle which is performing an automated parking event) is behind the own vehicle M, the parking position change determiner 426 may change the threshold to a smaller value and perform the foregoing determination. Thus, when it is assumed that a time is required for the parking operation of the own vehicle M, the parking space of the own vehicle M can be changed quickly and an influence on the parking operation of another vehicle can be reduced. Therefore, parking control in an entire parking lot can be efficient. When the parking position change determiner 426 determines that it is necessary to change the parking space, the parking controller 422 changes the parking space of the own vehicle M and transmits information regarding the changed parking space to the own vehicle M (step S111).

The parking position change determiner 426 may determine whether it is necessary to change the parking space based on presence or absence of another vehicle located behind the own vehicle M. FIG. 15 is a diagram showing an example of a parking operation for the own vehicle M when there is a following vehicle according to the embodiment. When another vehicle m7 which is a following vehicle is behind the own vehicle M and another empty parking space PS-2 is in front (a travel direction) of the own vehicle M, the parking position change determiner 426 may determine that it is necessary to change the parking space SP. Consequently, the parking controller 422 may determine the other empty parking space PS-2 located in front of the own vehicle M as a new parking space and transmit information regarding the new parking space to the own vehicle M.

The autonomous parking controller 142 of the automated driving control device 100 continues to determine whether the information regarding a change in the parking space PS has been received from the parking lot management device 400 during the parking operation (step S211). When the autonomous parking controller 142 determines to receive the information regarding a change in the parking space PS, the autonomous parking controller 142 starts controlling movement to the new parking space PS based on the information regarding the change (step S213). When the autonomous parking controller 142 determines not to receive the information regarding a change in the parking space PS, the autonomous parking controller 142 continues to control the movement to the currently set parking space PS. After the autonomous parking controller 142 starts controlling the movement to the new parking space PS in the foregoing step S213, the autonomous parking controller 142 may perform the flow subsequent to the foregoing step S203 again (that is, the flow subsequent to the process of determining whether the movement of the own vehicle M to the new parking space PS is completed).

Subsequently, the autonomous parking controller 142 determines whether the parking operation to the parking space PS is completed (step S215). When the autonomous parking controller 142 determines that the parking operation to the parking space PS is not completed, the autonomous parking controller 142 continuously controls the movement to the currently set parking space PS and determines whether the information regarding a change in the parking space PS has been received.

Conversely, when the autonomous parking controller 142 determines that the parking operation to the parking space PS is completed, the autonomous parking controller 142 transmits parking information indicating the completion of the parking operation to the parking lot management device 400 (step S217). The parking information may include, for example, information regarding a result value of a time required for an actual parking operation.

When the parking lot management device 400 receives the parking information transmitted by the automated driving control device 100, the parking lot management device 400 registers the parking information in the parking space state table 434 and the parking history information 436 stored in the storage 430 (step S113). Then, the process of the flowchart is completed.

Some of the functions of the automated driving control device 100 according to the foregoing embodiment may be realized in the parking lot management device 400. For example, the function of the predicted time calculator 144 of the automated driving control device 100 may be realized in the parking lot management device 400. In this case, the automated driving control device 100 may transmit the surrounding information recognized by the surrounding recognizer 134 to the parking lot management device 400, and the parking lot management device 400 may calculate the predicted time based on the surrounding information.

Some of the functions of the parking lot management device 400 described in the foregoing embodiment may be realized in the automated driving control device 100. For example, the functions of the target time calculator 424 and/or the parking position change determiner 426 of the parking lot management device 400 may be realized in the automated driving control device 100. In this case, the parking lot management device 400 may transmit the parking history information to the automated driving control device 100, and the automated driving control device 100 may calculate the target time based on the parking history information. Based on the target time and the predicted time, the automated driving control device 100 may determine whether it is necessary to change the parking position.

When the predicted time received from the own vehicle M is longer than the predetermined threshold (when a change in the parking position occurs), the parking controller 422 of the parking lot management device 400 may transmit information regarding the predicted time to a vehicle following the own vehicle M. When it is determined based on the surrounding information received from the own vehicle M that there is a factor that has an influence on the automated parking to the parking space PS (for example, it is determined that another vehicle which is stopping in a parking space adjacent to the parking space PS is stopping at a position close to the parking space PS) and when the parking space of the own vehicle M is changed to another parking space, the parking controller 422 may subsequently guide only a small vehicle to the parking space SP before the change. That is, when the predicted time received by the communicator 410 is longer than the predetermined threshold, the parking controller 422 may perform control such that the parking space associated with the predicted time is not set as the parking space of another subsequent vehicle. By performing such control, it is possible to improve precision when a parking instruction is given to another vehicle.

According to the above-described embodiment, optimum parking control in consideration of a situation of an actual parking position can be performed in the automated parking process of automated valet parking. By changing the parking position of the vehicle based on the predicted time calculated in consideration of the situation of the actual parking position, it is possible to shorten a time required for parking in the vehicle and optimize the parking control for another subsequent vehicle. By calculating an accurate predicted time based on content of information included in a surrounding situation of a parking position, it is possible to perform more optimum parking control.

### [Hardware Configuration]

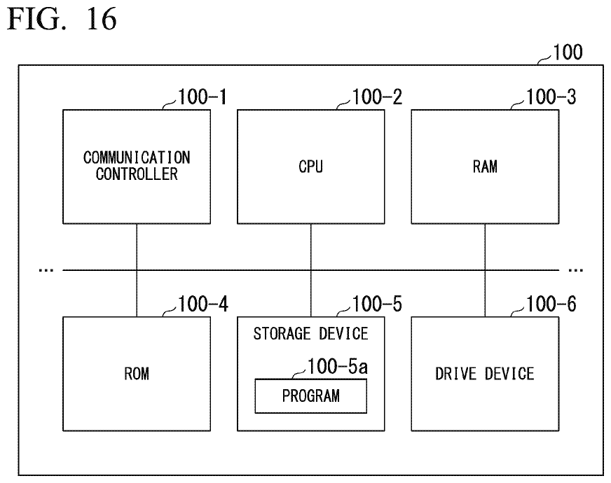

FIG. 16 is a diagram showing an example of a hardware configuration of the automated driving control device 100 according to an embodiment. As shown, the automated driving control device 100 (computer) is configured such that a communication controller 100-1, a CPU 100-2, a random access memory (RAM) 100-3 that is used as a working memory, a read-only memory (ROM) 100-4 that stores a boot program or the like, a storage device 100-5 such as a flash memory or a hard disk drive (HDD), a drive device 100-6, and the like are connected to each other via an internal bus or a dedicated communication line. The communication controller 100-1 performs communication with constituent element other than the automated driving control device 100. The storage device 100-5 stores a program 100-5a that is executed by the CPU 100-2. The program is loaded on the RAM 100-3 by a direct memory access (DMA) controller (not shown) to be executed by the CPU 100-2. Thus, some or all of the first controller 120 and the second controller 160 are realized.

The above-described embodiment can be expressed as follows:

the vehicle control device mountable in a vehicle including a storage device that stores a program and a hardware processor, the vehicle control device causing the hardware processor to execute the program stored in the storage device,

to calculate a predicted time required for automated parking of the vehicle at a parking position; and

to transmit information regarding the calculated predicted time to a vehicle management device managing parking of the vehicle.

The above-described embodiment can be expressed as follows:

the vehicle management device for managing parking of a vehicle including a storage device that stores a program and a hardware processor, the vehicle control device causing the hardware processor to execute the program stored in the storage device,

to transmit information regarding a parking position to the vehicle and to receive information regarding a predicted time required for automated parking of the vehicle at the parking position from the vehicle;

to determine whether it is necessary to change the parking position based on the received predicted time and a target time required for the automated parking; and

to change the parking position and to transmit information regarding the changed parking position in a case in which it is determined that it is necessary to change the parking position.

The embodiments for carrying out the present invention have been described above, but the present invention is not limited to the embodiments. Various modifications and substitutions can be made within the scope of the present invention without departing from the gist of the present invention.

What is claimed is:

1. A vehicle control device mountable in a vehicle, the vehicle control device comprising:
a predicted time calculator configured to calculate a predicted time required for automated parking of the vehicle at a parking position; and
a transmitter configured to transmit information regarding the predicted time calculated by the predicted time calculator to a vehicle management device for managing parking of the vehicle.

2. The vehicle control device according to claim 1, wherein the predicted time calculator is configured to calculate the predicted time which is a predicted value of a time necessary to stop at a parking position after the vehicle reaches the parking position and starts a parking operation.

3. The vehicle control device according to claim 1, further comprising:
a recognizer configured to recognize surrounding information of the vehicle,
wherein the predicted time calculator is configured to calculate the predicted time according to the surrounding information recognized by the recognizer.

4. The vehicle control device according to claim 3, wherein the predicted time calculator is configured to calculate the predicted time, the predicted time in a case in which the surrounding information indicates presence of a factor that has an influence on the automated parking being longer than the predicted time in a case in which the surrounding information does not indicate presence of the factor.

5. The vehicle control device according to claim 3, wherein the predicted time calculator is configured to calculate the predicted time, the predicted time in a case in which there is another vehicle near the parking position of the vehicle being longer than the predicted time in a case in which there is no another vehicle near the parking position.

6. The vehicle control device according to claim 3, wherein the predicted time calculator is configured to calculate the predicted time according to a period of time in which the vehicle performs the automated parking.

7. The vehicle control device according to claim 3, wherein the predicted time calculator is configured to calculate the predicted time according to brightness or weather of the parking position of the vehicle.

8. A vehicle management device for managing parking of a vehicle, the vehicle management device comprising:
a communicator configured to transmit information regarding a parking position to the vehicle and to receive information regarding a predicted time required for automated parking of the vehicle at the parking position from the vehicle;
a determiner configured to determine whether it is necessary to change the parking position according to the predicted time received by the communicator and a target time required for the automated parking; and
a parking controller configured to change the parking position and to cause the communicator to transmit information regarding the changed parking position in a case in which the determiner determines that it is necessary to change the parking position.

9. The vehicle management device according to claim 8, wherein the determiner is configured to determine that it is necessary to change the parking position in a case in which a separation between the predicted time and the target time is equal to or greater than a predetermined time.

10. The vehicle management device according to claim 8, wherein the communicator is configured to transmit the target time to the vehicle.

11. The vehicle management device according to claim 8, further comprising:
a target time calculator configured to calculate the target time according to a past parking result of the vehicle.

12. The vehicle management device according to claim 11, wherein the target time calculator is configured to calculate an average value of past times required for parking of the vehicle as the target time.

13. The vehicle management device according to claim 11, wherein the target time calculator is configured to calculate the target time according to a type of another vehicle stopping at another parking position adjacent to the parking position.

14. The vehicle management device according to claim 8,
wherein the communicator is configured to receive surrounding information of the vehicle from the vehicle, and
wherein the determiner is configured to determine that it is necessary to change the parking position in a case in which the surrounding information indicates that there is another vehicle behind the vehicle.

15. The vehicle management device according to claim 14, wherein the parking controller is configured to change the parking position to another parking position located in a travel direction of the vehicle.

16. The vehicle management device according to claim 8, wherein the parking controller is configured to perform control not to set the parking position associated with the predicted time as a parking position of another subsequent vehicle in a case in which the predicted time received by the communicator is greater than a predetermined threshold.

17. A vehicle control method using a computer of a vehicle control device mountable in a vehicle, the vehicle control method comprising:
calculating a predicted time required for automated parking of the vehicle at a parking position; and
transmitting information regarding the calculated predicted time to a vehicle management device for managing parking of the vehicle.

18. A vehicle management method using a computer of a vehicle management device for managing parking of a vehicle, the vehicle management method comprising:
transmitting information regarding a parking position to the vehicle and receiving information regarding a predicted time required for automated parking of the vehicle at the parking position from the vehicle;
determining whether it is necessary to change the parking position according to the received predicted time and a target time required for the automated parking; and
changing the parking position and transmitting information regarding the changed parking position in a case in which it is determined that it is necessary to change the parking position.

19. A computer-readable non-transitory storage medium that stores a program causing a computer of a vehicle control device mountable in a vehicle:
to calculate a predicted time required for automated parking of the vehicle at a parking position; and
to transmit information regarding the calculated predicted time to a vehicle management device for managing parking of the vehicle.

20. A computer-readable non-transitory storage medium that stores a program causing a computer of a vehicle management device for managing parking of a vehicle:
to transmit information regarding a parking position to the vehicle and to receive information regarding a predicted time required for automated parking of the vehicle at the parking position from the vehicle;
to determine whether it is necessary to change the parking position according to the received predicted time and a target time required for the automated parking; and
to change the parking position and to transmit information regarding the changed parking position in a case in which it is determined that it is necessary to change the parking position.
